(19) United States
(12) Patent Application Publication
(10) Pub. No.: US 2006/0266179 A1
(43) Pub. Date: Nov. 30, 2006

(54) Rotary cutter and method for adjusting fixing angle of stationary blade in rotary cutter

(75) Inventor: Kyoichi Yamashita, Yokohama-shi (JP)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: KOYO JIDOKI CO., LTD., Yokohama-shi (JP)

(21) Appl. No.: 11/130,477

(22) Filed: May 16, 2005

(51) Int. Cl. B26D 7/06

(52) U.S. Cl. 83/130

(57) ABSTRACT

A rotary cutter is configured such that a stationary cutter includes: an oscillating member oscillatably pivoted on a strut; a stationary blade projecting on one side of the oscillating member; oscillation restricting means for restricting oscillation of the oscillating member in one direction; a resilient member for applying an urging force to the oscillating member at all times in a direction in which the oscillation is restricted; and oscillating means for forcibly applying an oscillating force to the oscillating member; wherein the oscillating member is supported at three points, that is, a contact point between the resilient member and the oscillating member, a contact point between the oscillation restricting means and the oscillating member, and a pivotal point of the strut of the oscillating member. Thus, it is possible to adjust a fixing angle of the stationary blade at a proper angle by a simple operation and reduce the cost of the rotary cutter.

### BACKGROUND OF THE INVENTION

1. Field of the Invention

The invention relates to a rotary cutter applicable to a labeling machine or a printer and, more particularly, to a rotary cutter for continuously cutting a tape-like sheet in a precise length and a method for adjusting a fixing angle of a stationary blade in the rotary cutter.

2. Description of the Related Art

FIG. 7 is a view showing a model of a rotary cutter installed in a labeling machine.

A conventional rotary cutter comprises a cutter drum 10, which is rotated in one direction on a strut 11, and a stationary cutter 20 arranged in a manner facing to the cutter drum 10.

A stationary blade 21 projects from the stationary cutter 20. A facing distance between a blade tip of the stationary blade 21 and a rotary blade 12 disposed at the cutter drum 10 can be designed to be manually adjusted.

The cutter drum 10 includes the rotary blade 12 projecting from the outer peripheral surface thereof and a servo motor 30 for driving the cutter drum 10. The servo motor 30 is electrically connected to a control unit 31.

A supply roller 32, which consists of a pair of rotary rollers so as to supply a roll label L, also is provided with a servo motor 33 serving as a drive source. The servo motor 33 also is electrically connected to the control unit 31.

Furthermore, a photoelectric tube, not shown, is provided on the way of a conveying path for the roll label, for reading a cutting interval mark, which is marked on the roll label, so as to input such information to the control unit 31.

A program for controlling the rotation of each of the servo motors 30 and 33 of the cutter drum 10 and the supply roller 32, respectively, is stored in the control unit 31 in such a manner that the roll label L is cut in a predetermined length according to an operating speed of the machine.

However, the above-described rotary cutter in the prior art has had problems to be solved, as follows:

(1) It is necessary to adjust a clearance between the rotary blade 12 and the stationary blade 21 again if either one of the rotary blade 12 and the stationary blade 21 is replaced with a new one or the blade is abraded.

A work for adjusting the clearance between both of the blades 12 and 21 requires much time and labor for fine adjustment of the clearance by screwing and feeding the stationary blade 20 while visually observing the blade tip and for repetition of many cutting tests for actually cutting the label.

In particular, in the rotary cutter installed in the labeling machine, a cutting work is forced at a high speed with respect to 400 to 700 pieces of extra thin roll label sheets per minute, and therefore, the adjustment accuracy of both of the blades 12 and 21 markedly influences on a cutting level of the label, resulting in the difficulty of the adjusting work of both of the blades.

(2) If the blade tips slightly excessively project caused by inaccurate adjustment of both of the blades 12 and 21, either one of the blades 12 and 21 is broken. In contrast, if a slight clearance is defined between the blades 12 and 21, a cut surface of the label becomes uneven, thereby raising a problem of production of a deficient label.

(3) Since the rotations of the cutter drum 10 and the supply roller 32 are controlled by the servo motors, respectively, the roll label L cannot be cut during a period of time till the synchronization of rotational timings of the cutter drum 10 and the supply roller 32 with each other at the time of restart of operation after interruption of the operation of the rotary cutter.

This period of time is a waiting time. Improvements are required from the viewpoints of not only operating efficiency of the rotary cutter but also operating efficiency of the labeling machine.

(4) Each of the servo motors 30 and 33 requires additional equipment such as an encoder and a transmission or a control program. The cost of the rotary cutter including such additional equipment becomes high several times or more that of a general versatile motor.

### SUMMARY OF THE INVENTION

The invention has been accomplished to solve the above-described problems experienced in the prior art. Therefore, an object of the invention is to provide a rotary cutter and a method for adjusting a fixing angle of a stationary blade in the rotary cutter, in which a blade tip can be readily adjusted with accuracy.

Another object of the invention is to provide a rotary cutter and a method for adjusting a fixing angle of a stationary blade in the rotary cutter, in which the cost of the rotary cutter can be reduced.

According to a first aspect of the invention, a rotary cutter comprises: a cutter drum, which is rotated in one direction on a strut and has a rotary blade at the outer periphery thereof; and a stationary cutter disposed in a manner facing to the cutter drum, the stationary cutter including: an oscillating member oscillatably pivoted on the strut; a stationary blade projecting on one side of the oscillating member; oscillation restricting means for restricting oscillation of the oscillating member in one direction; a resilient member for applying an urging force to the oscillating member at all times in a direction in which the oscillation is restricted; and oscillating means for forcibly applying an oscillating force to the oscillating member; wherein the oscillating member is supported at three points, that is, a contact point between the resilient member and the oscillating member, a contact point between the oscillation restricting means and the oscillating member, and a pivotal point of the strut of the oscillating member.

In the above-described rotary cutter, the oscillation restricting means may be constituted of an adjusting bolt screwed in a stationary member disposed in a manner facing to a side surface of the oscillating member, and can adjust a fixing angle of the stationary blade disposed integrally with the oscillating member by rotating the adjusting bolt.

Furthermore, in the above-described rotary cutter, a drive source for the cutter drum may be a versatile motor.

In any one of the above-described rotary cutters, the rotation of the cutter drum may be continued when the oscillating means forcibly oscillates the oscillating member disposed integrally with the stationary blade.

According to a second aspect of the invention, a method for adjusting a fixing angle of a stationary blade in a rotary cutter, in which any one of the above-described rotary cutters is used, comprises the step of rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

The invention can produce at least one of peculiar effects, as follows:

(1) Since the oscillating member disposed integrally with the stationary blade is supported at the three points, a play can be eliminated at the pivotal point of the oscillating member, so that the oscillating member can be supported without any fluctuation. Furthermore, the blade tips of the stationary blade and the rotary blade can be adjusted at a precise cutting point by simple adjusting operations such as the manually rotating operation of the cutter drum and the rotating operation of the adjusting bolt.

(2) The oscillating member is oscillated in one direction by using the resilient member as one of the members for supporting the oscillating member.

As a consequence, the cutting operation can be interrupted by forcibly oscillating the oscillating member while the cutter drum is continuously rotated, and further, the cutting operation can be performed only by returning the oscillating member to an original position, thereby almost eliminating a waiting time and remarkably enhancing cutting efficiency.

(3) The versatile motor can be used as the drive source for the cutter drum, thereby obviating a conventional servo motor and a program for controlling the servo motor, so as to reduce the cost of the rotary cutter.

(4) The fluctuation can be completely eliminated at the pivotal point of the oscillating member by combining the oscillation restricting means such as the adjusting bolt with the resilient member such as the spring member, thereby precisely determining the oscillatory center of the stationary blade.

As a result, an abrasion of the blade tip can be compensated only by oscillating the oscillating member without replacing the blade with a new one even in the case where the blade is abraded, thus remarkably prolonging the durable lifetime of the rotary cutter.

### BRIEF DESCRIPTION OF THE DRAWINGS

The above and other objects, features, advantages and technical and industrial significance of this invention will be better understood by the following detailed description of the preferred embodiments, when considered in connection with the accompanying drawings, in which:

FIG. 1 is a view conceptually showing a rotary cutter according to the invention;

FIG. 2 is an exploded assembly view showing a stationary blade;

FIG. 3 is a view explanatory of a method for adjusting the stationary blade at an angle of 0°;

FIG. 4 is a view explanatory of the stationary blade, which is oscillated, in the rotary cutter;

FIG. 5 is a diagram explanatory of the principle of formation of a plurality of cutting points by the stationary blade and a rotary blade;

FIG. 6 is a view explanatory of a structure for adjusting a projection of the stationary blade; and

FIG. 7 is a view explanatory of the rotary cutter, on which the invention is predicated.

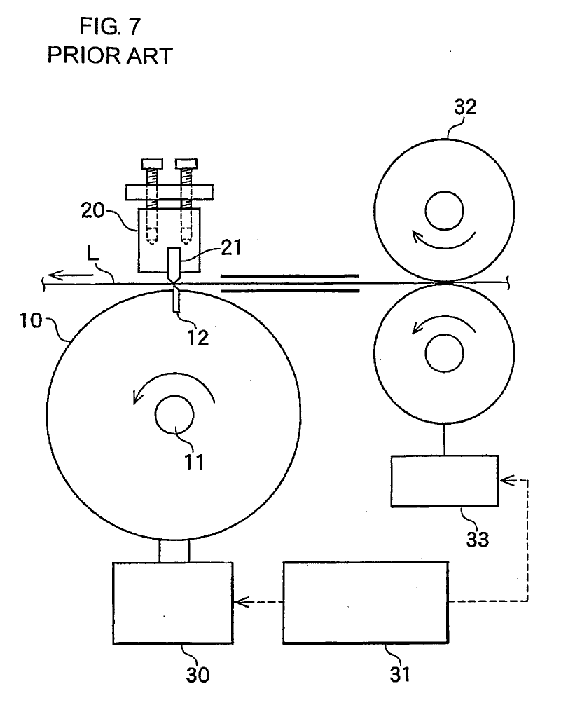

### DETAILED DESCRIPTION OF THE PREFERRED EMBODIMENTS

A description will be given below of preferred embodiments according to the invention in reference to the attached drawings.

### (1) Outline of Rotary Cutter

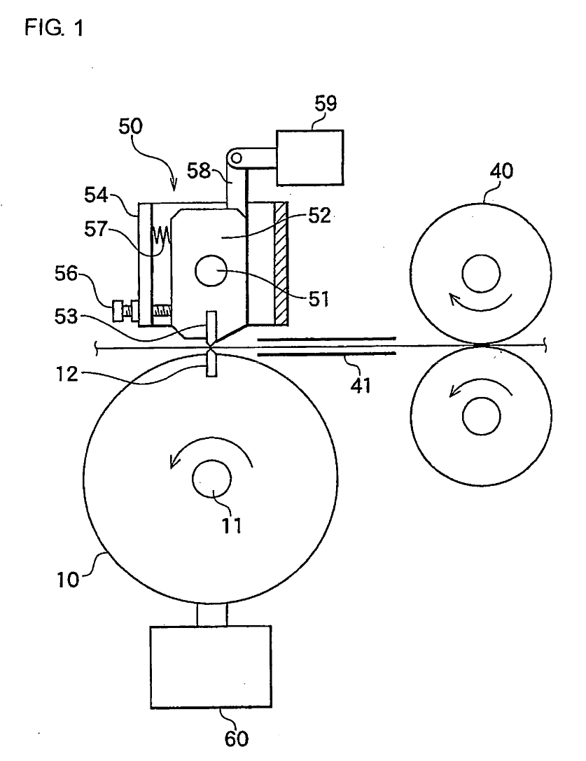

FIG. 1 is a view showing a model of a rotary cutter.

A supply roller 40 consisting of a pair of rollers is located on the right in FIG. 1. Moreover, a guide plate 41 for introducing a roll label is positioned in front of the supply roller 40. A rotary cutter is installed on the left of the guide plate 41.

No servo motor is used as a drive source for the supply roller 40. A gear mechanism can satisfactorily serve as a drive source for the supply roller 40.

The rotary cutter comprises a cutter drum 10, which is rotated in one direction on a strut 11, and a stationary cutter 50 disposed in a manner facing to the cutter drum 10, like in the prior art. However, the invention is different from the prior art in that no servo motor is used as the drive sources for the cutter drum 10 and the supply roller 40, respectively, and that the stationary cutter 50 is designed to be of an oscillation type. Hereinafter, explanation will be made on each of the component parts.

### (2) Cutter Drum

A rotary blade 12 projects from the outer peripheral surface of the cutter drum 10.

According to the invention, no expensive servo motor is used as the drive source for the cutter drum 10, and therefore, no program for controlling a servo motor is required, but an inexpensive versatile motor 60 is used as the drive source for the cutter drum 10.

The rotary cutter is configured such that its operation can be interrupted while the cutter drum 10 is kept to be rotated by oscillating the stationary cutter 50, and thus, the versatile motor 60 can be used as the drive source for the cutter drum 10.

### (3) Stationary Cutter

The stationary cutter 50 includes an oscillating member 52 oscillatably pivoted on a strut 51, a stationary blade 53 projecting on one side of the oscillating member 52, oscillation restricting means for restricting clockwise oscillation of the oscillating member 52, a resilient member for applying an urging force to the oscillating member 52 clockwise at all times, and oscillating means for forcibly applying an oscillating force to the oscillating member 52.

[Oscillating Member]

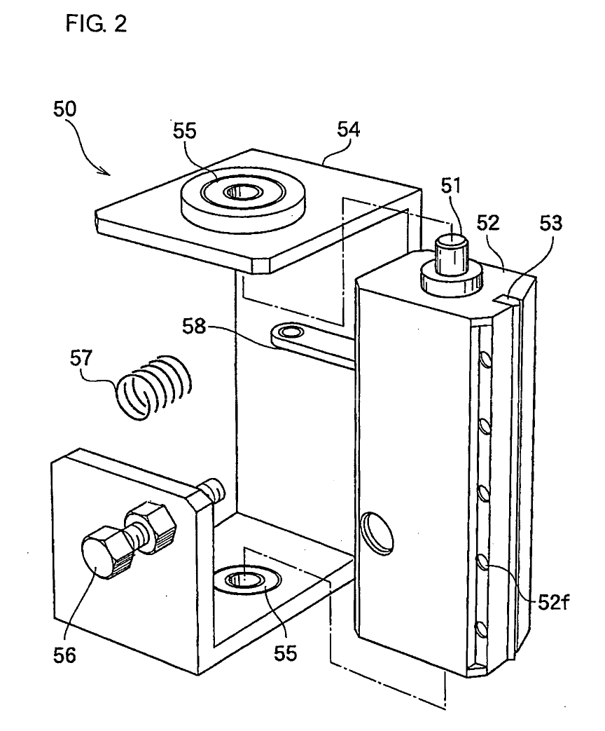

FIG. 2 is a view showing one example of the stationary cutter 50 excluding the oscillating means.

Bearings 55 and 55 are disposed on the same vertical line at an upper and a lower plate of a frame 54 having a substantially U shape as a whole. The struts 51 and 51 projecting upward and downward of the oscillating member 52 are rotatably pivoted through the bearings 55 and 55, respectively.

The struts 51 and 51 projecting from the oscillating member 52 may be directly pivoted on the frame 54 without using any bearing 55.

The side surface of the oscillating member 52 having the stationary blade 53 disposed therein may be flat. However, an advantage of smooth guidance of a tip of a roll label to a blade tip can be produced by slantwise chamfering the side surface on the side of the supply roller 40 apart from the stationary blade 53.

[Oscillation Restricting Means]

An adjusting bolt 56 serving as the oscillation restricting means is fitted through one side surface of the frame 54 facing to the side surface of the oscillating member 52 and on a side nearer the stationary blade 53 with respect to the strut 51.

The adjusting bolt 56 functions as not only a stopper member for restricting clockwise oscillation of the oscillating member 52 by bringing its tip into contact with the side surface of the oscillating member 52 to a constant level but also a member for adjusting a fixing angle of the oscillating member 52, that is, a fixing angle of the stationary blade 53 by adjusting a projection of the adjusting bolt 56.

[Resilient Member]

A spring member 57 serving as the resilient member is interposed in a contractile state between the same side surface of the frame 54 as the side surface, at which the adjusting bolt 56 is fitted, and the oscillating member 52.

The spring member 57 is a resilient member having the functions of absorbing a fluctuation at the pivotal point of the oscillating member 52, supporting the oscillating member 52 without any fluctuation and allowing the oscillation of the oscillating member 52 in order to adjust the blade tips of the stationary blade 53 and the rotary blade 12. The spring member 57 is disposed on a side opposite to the stationary blade 53 with the strut 51 held therebetween, such that resiliency acts at all times in a direction in which the side surface of the oscillating member 52 abuts against the adjusting bolt 56.

Namely, the adjusting bolt 56, the strut of the oscillating member 52 and the spring member 57 are arranged in order from the cutter drum 10.

The above-described oscillation restricting means is not limited to the mode as shown, but known means capable of adjusting a projection other than the bolt may be used.

Moreover, various kinds of resilient members may be used as the above-described resilient member other than a coil spring. Additionally, the resilient member may be disposed in not the contractile state but an extensile state, so that tension is generated in the above-described urging direction.

[Oscillating Means]

As shown in FIG. 1, a link member 58 extends from the oscillating member 52 on a side opposite to the side of the stationary blade 32, and further, is connected at the end thereof to oscillating means 59.

The oscillating means 59 is adapted to forcibly oscillate the oscillating member 52 disposed integrally with the stationary blade 52 so as to interrupt a cutting operation with respect to the roll label. For example, a solenoid, which is displaced by energization, various kinds of fluid cylinders, a screw feeding mechanism and the like may be applied to the oscillating means 59, and further, an air cylinder is preferable since a structure is simple and an operating speed is high.

The oscillating means 59 may be operated by manual control, but may be operated by automatic control in response to a sensing signal when stoppage or interruption of operation of the labeling machine is sensed in the form of an electric signal. The automatic control does not require any special complicated program, and therefore, the control can be achieved with remarkable ease.

### (4) Operations

Subsequently, a description will be given of the operation of the rotary cutter.

[Supporting Structure for Stationary Blade]

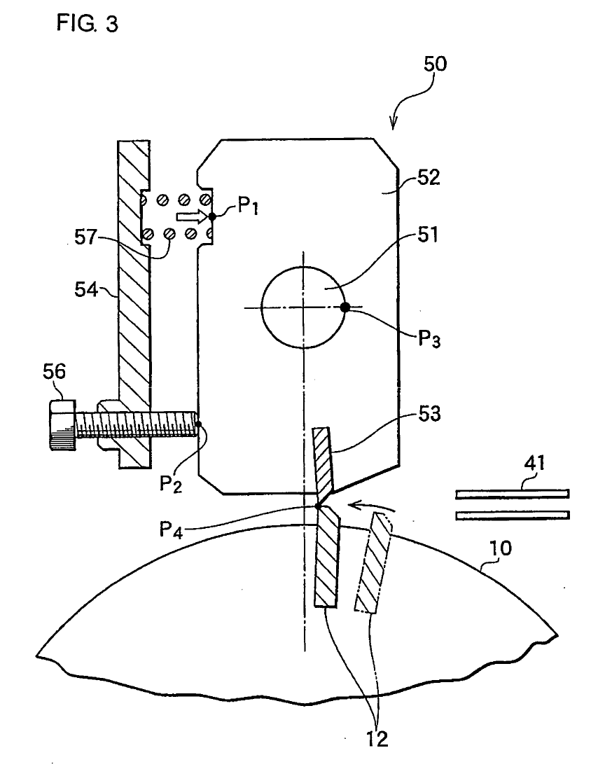

The rotary cutter according to the invention is configured such that the oscillating member 52 having the stationary blade 53 can be supported at three points, as shown in FIG. 3.

Assuming that reference character P₁ designates a contact point between the spring member 57 and the oscillating member 52, reference character P₂ denotes a contact point between the adjusting bolt 56 and the oscillating member 52 and reference character P₃ designates a pivotal point of the strut 51 in the oscillating member 52, the oscillating member 52 disposed integrally with the stationary blade 53 is pivotally supported at the three points without any fluctuation.

It is very difficult to pivotally support the oscillating member 52 without any displacement of the oscillatory center of the strut 51 merely by supporting the strut 51 by the bearing since the bearing has a play.

According to the invention, the oscillating member 52 can be stopped at a predetermined position without any influence by the play of the bearing by combining the spring member 57 with the adjusting bolt 56 for use.

The contact point P₁ between the spring member 57 and the oscillating member 52 serves as a force point and the contact point P₂ between the adjusting bolt 56 and the oscillating member 52 serves as a fulcrum by adopting the configuration in which the adjusting bolt 56 and the spring member 57 are arranged forward and backward of the strut 51, so that the pivotal point P₃ of the strut 51 in the oscillating member 52 is deviated in one direction, thereby substantially obviating a play at the pivotal point P₃.

Consequently, the oscillatory center of the oscillating member 52 is not displaced irrespective of the magnitude of the fluctuation of the bearing.

[Adjustment of Fixing Angle of Stationary Blade]

The blade tips of the stationary blade 53 constituting the stationary cutter 50 and the rotary blade 12 in the cutter drum 10 are finely adjusted by forward and reverse rotation of the adjusting bolt 56 and the reverse rotation of the cutter drum 10. A description will be given below of a specific method for adjusting the blade tip.

As shown in FIG. 3, when the cutter drum 10 is manually and slowly rotated in a reverse direction so that the rotary blade 12 passes from downstream to upstream of the stationary blade 53 (i.e., rightward in FIG. 3), it is checked as to whether or not the oscillating member 52 is oscillated.

If the rotary blade 53 abuts against the stationary blade 12 so that the oscillating member 52 contracts the spring member 57, to be thus oscillated counterclockwise on the pivotal point of the strut 51, this reveals that the blade tip of the stationary blade 12 further intrudes toward the rotary blade 12 beyond a predetermined cutting point P₄.

The adjusting bolt 56 is rotated according to an oscillation of the oscillating member 52, thus finely adjusting the fixing angle of the oscillating member 52.

Thereafter, if no oscillation of the oscillating member 52 is observed when the rotary blade 53 passes, it is found that the blade tip of the stationary blade 53 accords with the predetermined cutting point P₄ at that point.

In this manner, the fixing angle of the stationary blade 53 can be accurately adjusted with ease only by slowly rotating the cutter drum 10 and checking as to whether or not the oscillating member 52 is oscillated. Moreover, no gauge or the like is required for the adjusting work for allowing the blade tip of the stationary blade 53 to accord with the predetermined cutting point P₄.

[Cutting Operation]

In FIG. 1, the cutter drum 10 is driven by the versatile motor 60, to be thus rotated counterclockwise. When continuous supply of the roll label is started by the supply roller 40 in this state, the roll label is conveyed toward the rotary cutter via the guide plate 41, and then, passes between the cutter drum 10 and the stationary cutter 50.

The instant that the rotary blade 12 in the cutter drum 10 passes through the stationary blade 53 in the stationary cutter 50, the roll label is cut in a predetermined length.

Incidentally, a clockwise rotational force acts on the oscillating member 52 during the cutting operation of the label. However, the force is supported by the adjusting bolt 56 in abutment against the side surface of the oscillating member 52, thereby keeping the oscillating member 52 in a stopped state without any oscillation.

Additionally, as described above, since neither of the blades 12 and 53 are displaced from the predetermined cutting point P₄ without any fluctuation at the pivotal point serving as the oscillatory center of the oscillating member 52, the label can be efficiently cut with a clear cut surface.

[Interruption of Cutting Operation]

In the case of replacement of the roll label or the like, the cutting operation by the rotary cutter need be interrupted temporarily.

When the cutting operation is interrupted, the supply of the roll label is stopped, and simultaneously, the stationary cutter 50 is forcibly oscillated. At this time, the cutter drum 10 is continuously rotated.

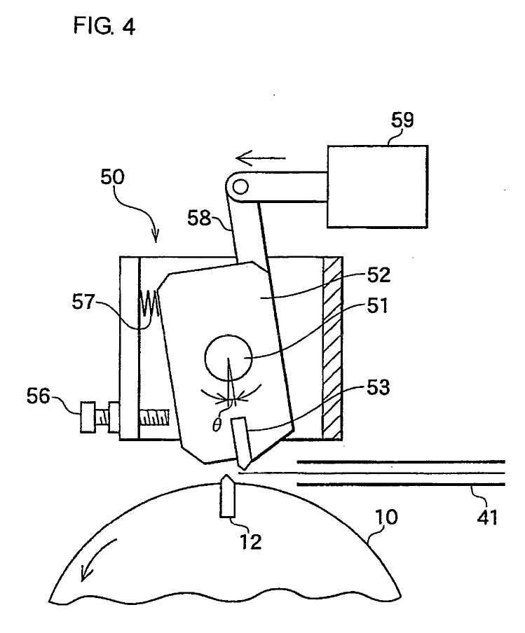

FIG. 4 is a view showing the rotary cutter at the time of the interruption of the cutting operation. When the oscillating means 59 in the stationary cutter 50 is actuated in an extensile direction, the oscillating member 52 disposed integrally with the stationary blade 53 via the ring member 58 is oscillated counterclockwise on the strut 51 while compressively deforming the spring member 57. An oscillatory angle sufficiently ranges from about 5° to about 9°.

Since the clearance is defined between the stationary blade 53 and the rotary blade 12 in association with the oscillation of the oscillating member 52, no cutting operation can be performed even if the cutter drum 10 is rotated.

[Restart of Cutting Operation]

Awaiting time till restart of operation has been long in the conventional rotary cutter using a servo motor.

In contrast, according to the invention, the rotation of the cutter drum 10 is continued also during the interruption, so that the cutting operation of the label can be instantaneously started again only by releasing the extension of the oscillating means 59 and returning the oscillating member 52 to the original position.

That is to say, when the extension of the oscillating means 59 is released, the oscillating member 52 is oscillated clockwise on the strut 51 by the resiliency accumulated in the spring member 57, and consequently, the side surface of the oscillating member 52 abuts against the adjusting bolt 56, thereby restricting the oscillation.

As a result, the oscillating member 52 can be supported again by the two contact points P₁ and P₂ and the pivotal point P₃ without any fluctuation, as shown in FIG. 3, and thus, the stationary blade 53 is returned to the predetermined cutting point P₄.

In the case of the restart of the cutting operation, the oscillating member 52 is automatically returned to the original position, thereby dispensing with any re-adjusting operation of the fixing angle of the stationary blade 53.

[Abrasion of Blade]

The stationary blade 53 and the rotary blade 12 suffer from abrasion caused by the label cutting operation.

In the case where the blades 53 and 12 are abraded, another cutting point P₄ can be set by slightly rotating the adjusting bolt 56 in a retreat direction according to the invention.

As a consequence, it is possible to remarkably prolong the durable lifetime of the rotary cutter.

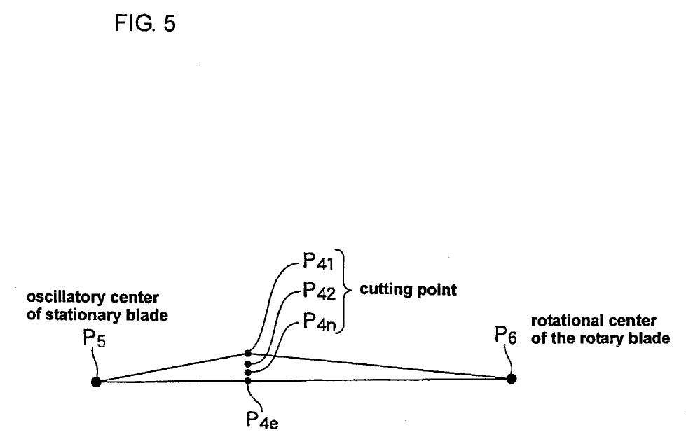

Explanation will be made below on the reason of setting another cutting point P₄ in reference to FIG. 5.

In FIG. 5, reference character P₅ designates the oscillatory center of the stationary blade 53; and reference character P₆ denotes the rotational center of the rotary blade 12.

Although the oscillating member 53 is of an oscillation type, the oscillatory center of the stationary blade 53 is not deviated, as described already. In addition, the rotational center of the rotary blade 12 is not deviated, either.

Therefore, if a first cutting point P₄₁ is set nearer the label supply side (i.e., upward in FIG. 5) than a line connecting the centers of both of the blades 53 and 12, other cutting points P₄₂ and P₄ₙ can be set by oscillating the stationary blade 53 on the oscillatory center P₅ according to the abrasion of the blade.

A new cutting point P₄ₑ can be set to a lower limit on the line connecting the centers of both of the blades 53 and 12.

In this manner, even if the stationary blade 53 is oscillatably configured, the precise cutting point can be secured since the oscillatory center cannot be deviated.

Additionally, an oscillation radius of the stationary blade 53 and a pitch of the adjusting bolt 56 are known, so that the adjusting bolt 56 is rotated by a required angle according to an abrasion of the blade by previously calculating the oscillatory angle of the stationary blade 53 according to the rotational angle of the adjusting bolt 56, thereby setting a new cutting point.

### (5) Another Preferred Embodiment

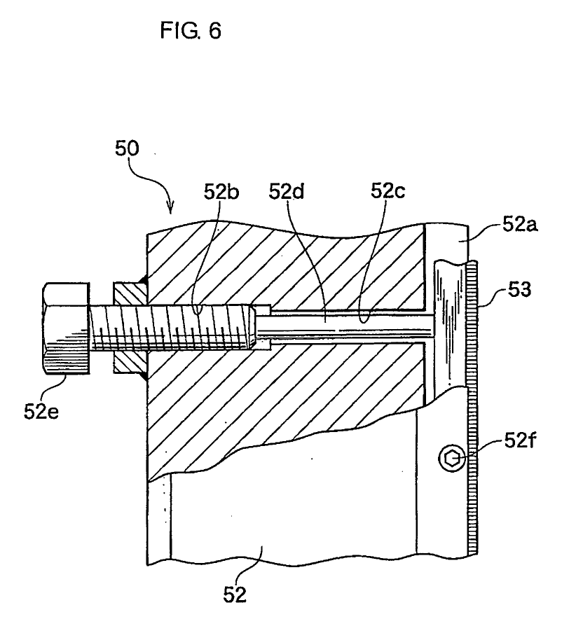

FIG. 6 is a view showing a configuration in another preferred embodiment, in which a vertical angle of a stationary blade 53 in a stationary cutter 50 can be adjusted.

A containing groove 52a having a width enough to contain the stationary blade 53 therein is formed at one side surface of an oscillating member 52, and further, a connecting hole 52c is formed in such a manner as to allow a bottom of each of a plurality of bolt holes 52b formed at a back surface of the oscillating member 52 in a multiply stepped manner to communicate with the containing groove 52a.

A rod member 52d for pressing the back surface of the stationary blade 53 is contained inside of the connecting hole 52c. A vertical angle of the stationary blade 53 can be finely adjusted via the rod member 52d by rotating a tightening bolt 52e screwed in the bolt hole 52b.

Moreover, a plurality of fixing screws 52f are disposed sideways of the containing groove 52a, so that the stationary blade 53 whose projection has been adjusted can be securely pressed against the side surface of the containing groove 52a.

Although the description has been given above of the cutting operation of the roll label, perforations may be formed by intermittently forming the blade tip of either one of the rotary blade 12 and the stationary blade 63.

What is claimed is:

1. A rotary cutter comprising:
a cutter drum, which is rotated in one direction on a strut and has a rotary blade at the outer periphery thereof; and
a stationary cutter disposed in a manner facing to the cutter drum, the stationary cutter having:
an oscillating member oscillatably pivoted on the strut;
a stationary blade projecting on one side of the oscillating member;
oscillation restricting means for restricting oscillation of the oscillating member in one direction;
a resilient member for applying an urging force to the oscillating member at all times in a direction in which the oscillation is restricted; and
oscillating means for forcibly applying an oscillating force to the oscillating member;
wherein the oscillating member is supported at three points, that is, a contact point between the resilient member and the oscillating member, a contact point between the oscillation restricting means and the oscillating member, and a pivotal point of the strut of the oscillating member.

2. A rotary cutter according to claim 1, wherein the oscillation restricting means is constituted of an adjusting bolt screwed in a stationary member disposed in a manner facing to a side surface of the oscillating member, and can adjust a fixing angle of the stationary blade disposed integrally with the oscillating member by rotating the adjusting bolt.

3. A rotary cutter according to claim 1, wherein a drive source for the cutter drum is a versatile motor.

4. A rotary cutter according to claim 2, wherein a drive source for the cutter drum is a versatile motor.

5. A rotary cutter according to any one of claim 1, wherein the rotation of the cutter drum is continued when the oscillating means forcibly oscillates the oscillating member disposed integrally with the stationary blade.

6. A rotary cutter according to any one of claim 2, wherein the rotation of the cutter drum is continued when the oscillating means forcibly oscillates the oscillating member disposed integrally with the stationary blade.

7. A rotary cutter according to any one of claim 3, wherein the rotation of the cutter drum is continued when the oscillating means forcibly oscillates the oscillating member disposed integrally with the stationary blade.

8. A rotary cutter according to any one of claim 4, wherein the rotation of the cutter drum is continued when the oscillating means forcibly oscillates the oscillating member disposed integrally with the stationary blade.

9. A method for adjusting a fixing angle of a stationary blade in a rotary cutter, in which the rotary cutter according to any one of claim 2 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

10. A method for adjusting a fixing angle of a stationary blade in a rotary cutter, in which the rotary cutter according to any one of claim 3 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

11. A method for adjusting a fixing angle of a stationary blade in a rotary cutter, in which the rotary cutter according to any one of claim 4 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

12. A method for adjusting a fixing angle of a stationary blade in a rotary cutter, in which the rotary cutter according to any one of claim 5 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

13. A method for adjusting a fixing angle of a stationary blade in a rotary cutter, in which the rotary cutter according to any one of claim 6 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.

14. A method for adjusting a fixing angle of a stationary blade in a rotary cutter, in which the rotary cutter according to any one of claim 7 is used, the method comprising the step of:
rotationally operating an adjusting bolt to a position, at which an oscillating member cannot be oscillated out of contact of a rotary blade with a stationary blade after the stationary blade is allowed to pass through the rotary blade by manually rotating a cutter drum, so as to adjust a fixing angle of the oscillating member.
